(19) United States
(12) Patent Application Publication
(10) Pub. No.: US 2006/0149764 A1
(43) Pub. Date: Jul. 6, 2006

(54) Innovation management business competency model

(75) Inventors: Nancy L. Burchfield, Dana Point, CA (US); Paul C. Mugge, Cary, NC (US)

Correspondence Address: Steven Fischman, Esq.;Scully, Scott, Murphy & Presser, 400 Garden City Plaza, Garden City, NY, 11530, US

(73) Assignee: International Business Machines Corporation, Armonk, NY (US)

(21) Appl. No.: 11/015,551

(22) Filed: Dec. 17, 2004

(51) Int. Cl. G06F 7/00

(52) U.S. Cl. 707/101

(57) ABSTRACT

Disclosed are a method, system and computer program for assessing a client capability. The method comprises the step of providing a business model for a company, said model having defined capabilities, capability domains, key discipline areas having metrics, and specified proficiency levels including best practices proficiency levels. The method comprises the further steps of determining for each of said metrics a proficiency level for said client for each of said key discipline areas; rolling up said proficiency levels for said client by said capability; and communicating to said client, said proficiency levels for said client and said best practices proficiency levels. The preferred embodiment of the invention defines a comprehensive, integrated and collaborative model for the practice of innovation management.

### BACKGROUND OF THE INVENTION

1. Field of the Invention

This invention generally relates to managing innovation, and more specifically, the invention relates to assessing and managing the innovation capability of an enterprise. Even more specifically, the preferred embodiment of the invention provides a comprehensive, integrated and collaborative model for the practice of innovation management.

2. Background Art

Growth in earnings without corresponding growth in revenues is achieved primarily through cost reductions. Most corporate executives may be better at, and more comfortable with, controlling costs than creating innovative products that fuel top-line growth. However, “the low hanging fruit” has already been picked. The globalization of markets has created a highly competitive arena where survival depends on a continuous stream of successful new products. The next round of competitive positioning will be based on innovation, and a company's innovation capabilities will determine its future growth potential. This is creating a special challenge for senior management. Only innovation increases the size of the pie, which means its mastery is vital to a company's long-term well-being.

Innovation success depends on adopting a holistic perspective for managing innovation competency in four interrelated capabilities across the organization: Market Planning, Portfolio Management, Platform Management, and Pipeline Management. Yet there is no integrated, complete business model that defines these four essential innovation management capabilities. Existing product development models and frameworks focus either on pipeline management or portfolio management. Since existing models describe only a single capability, they do not identify the cross-capacity integration points required to succeed. Additionally, existing frameworks do not include a maturity model of how the capability can be improved. Organizations struggling to execute on their growth agendas do not have an end-to-end roadmap for how to build the innovation management competencies critical to their success.

### SUMMARY OF THE INVENTION

An object of this invention is to provide an innovation management business competency model.

Another object of the present invention is to offer client organizations a means to identify gaps or weaknesses in their management of innovation and to develop roadmaps for improvement.

A further object of the invention is to determine an organization's potential/optimal innovation capacity and to identify targeted key discipline areas and corresponding proficiency levels required to realize that innovation capacity.

These and other objectives are attained with a method, system and computer program for assessing a client capability. The method comprises the step of providing a business model for a company, said model having defined capabilities, capability domains, key discipline areas having metrics, and specified proficiency levels including best practices proficiency levels. The method comprises the further steps of determining for each of said metrics a proficiency level for said client for each of said key discipline areas; rolling up said proficiency levels for said client by said capability; and communicating to said client, said proficiency levels for said client and said best practices proficiency levels.

The preferred embodiment of the invention, referred to as the Innovation Management Business Competency Model (IMBCM) and described below in detail, defines a comprehensive, integrated and collaborative model for the practice of innovation management. The model identifies four capabilities: Market Planning, Portfolio Management, Platform Management, and Pipeline Management. Each of these capabilities contains the essential set of disciplines that address the complete, integrated set of capability components: Strategy, Organization, Process, Applications, and Infrastructure. Each discipline in IMBCM is associated with a competence level. The four competence levels in the IMBCM describe the improvement progression from initial, or minimal level of competence in developing innovative products up to the world-class level of driving growth through continuous innovation.

The IMBCM focuses on the competence of product development organizations to produce commercially successful products consistently and predictably. Innovation management competence is the inherent ability of product development to produce planned results. A firm's capacity to innovate is determined by the proficiency of the four above-identified capabilities: Market Planning, Portfolio Management, Platform Management, and Pipeline Management. Consistent with the resource-based view of a firm, resources (tangible and intangible) are the input to, and are transformed by, these capabilities to produce innovative output with increased future value.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a flow chart showing a preferred implementation of the present invention.

FIG. 2 illustrates a resource-based view of innovation.

FIG. 3 shows how proficiency levels can be used to provide a recommended order for how to tackle improvement initiatives.

FIG. 4 shows the relationship of the constituent parts of an innovation management capability.

### DETAILED DESCRIPTION OF THE PREFERRED EMBODIMENTS

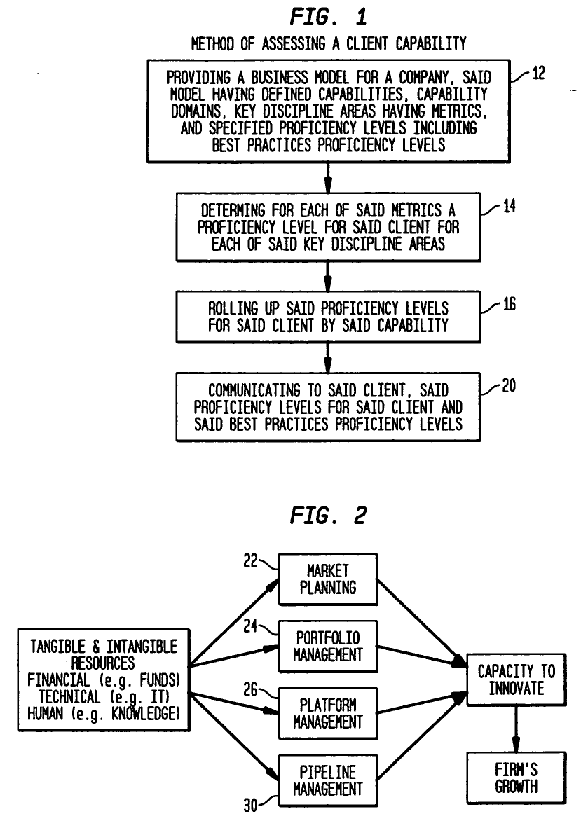

The present invention provides a method, system and computer program for assessing a client capability, and FIG. 1 illustrates a method that may be used to implement the invention. The method comprises the step 12 of providing a business model for a company, said model having defined capabilities, capability domains, key discipline areas having metrics, and specified proficiency levels including best practices proficiency levels. The method comprises the further step 14 of determining for each of said metrics a proficiency level for said client for each of said key discipline areas; Step 16 of rolling up said proficiency levels for said client by said capability; and step 20 of communicating to said client, said proficiency levels for said client and said best practices proficiency levels.

The preferred embodiment of the invention, referred to as the Innovation Management Business Competency Model (IMBCM), defines a comprehensive, integrated and collaborative model for the practice of innovation management. The model identifies four capabilities: Market Planning, Portfolio Management, Platform Management, and Pipeline Management. Each of these capabilities contains the essential set of disciplines that address the complete, integrated set of capability components: Strategy, Organization, Process, Applications, and Infrastructure. Each discipline in IMBCM is associated with a competence level. The four competence levels in the IMBCM describe the improvement progression from initial, or minimal, level of competence in developing innovative products up to the world-class level of driving growth through continuous innovation.

The IMBCM focuses on the competence of product development organizations to produce commercially successful products consistently and predictably. Innovation management competence is the inherent ability of product development to produce planned results. A firm's capacity to innovate is determined by the proficiency of the four above-identified capabilities: Market Planning, Portfolio Management, Platform Management, and Pipeline Management. Consistent with the resource-based view of a firm, resources (tangible and intangible) are the input to, and are transformed by, these capabilities to produce innovative output with increased future value. FIG. 2 illustrates this resource-based view of innovation.

In the model of FIG. 2, Market Planning 22 is the dynamic decisioning capability whereby the organization develops actionable, profitable business plans based on the rigorous, fact-based analysis of market trends, customer wants and needs, and opportunity prioritization.

Portfolio Management 24 is the dynamic decisioning capability whereby an organization's set of development projects is constantly updated and revised. New projects are evaluated, selected, and prioritized, existing projects may be accelerated, killed or reprioritized, and resources are allocated and reallocated to the active project set.

Platform Management 26 is the dynamic decisioning capability whereby the organization establishes the platform strategy, architecture, common building blocks, and development plan for a product family.

Pipeline Management 30 is the dynamic decisioning capability whereby the organization identifies, selects, reviews, and converges on the content of an individual development project as the project moves through a planned sequence of management intervention checkpoints.

IMBCM assigns key disciplines across the essential capabilities, market planning, portfolio management, platform management, and pipeline management. Within each capability, the key disciplines are organized into four capability domains (strategy, organization, process, and technology).

Innovation is a difficult and complex problem that is constrained in many dimensions. However, the importance (demand for) of a consistent flow of successful new products to the overall prosperity of the firm creates the need to continuously assess and improve an organization's innovation competence. The IMBCM offers client organizations a means to identify gaps or weaknesses in their management of innovation and to develop roadmaps for improvement.

The IMBCM framework is structured to enable innovation management improvement approaches to be planned at multiple levels, depending on the needs of the organization. These levels at which improvement can be planned include:
a) at an overall innovation management competency level, including all four of the capabilities—Market Planning, Portfolio Management, Platform Management, and Pipeline Management,
b) at an individual capability level, and
c) at an individual key discipline area (KDA) within a capability.
   IMBCM Capability Domains

An effective capability is a consistent set of four domains that together, as a system, creates economic value. The four domains are Strategy, Organization, Process, and Technology. These four domains are the “DNA” of a capability. Examining their content, i.e., the disciplines practiced, determines the level of proficiency of the overall capability. Once an organization has assessed the proficiency of its practices within a capability and has identified specific weak spots, they will need to construct a transformation plan for improvement. An effective transformation involves executing a plan to master all four domains of a capability.

IMBCM Key Discipline Areas (KDAs)

Key discipline areas indicate where the product development organization should focus in order to improve its innovation management capabilities. Organized by capability domain, KDAs identify the essential domain issues that must be addressed in order to achieve a level of proficiency. Each KDA identifies the disciplines that, when performed, achieve a set of goals essential for improving the related innovation management capability.

Each KDA is defined by a set of specific and generic goals and disciplines. Specific goals are implemented by specific disciplines and are unique to individual KDAs. Generic goals are implemented by generic disciplines and apply to multiple KDAs.

A KDA is a body of work or a collection of disciplines that an organization must master to carry out the essential work of an innovation management capability. KDAs help make the four essential capabilities (Market Planning, Portfolio Management, Platform Management, Pipeline Management) more achievable by defining sets of disciplines that are smaller and more tractable than a broad imperative such as “Perform Market Planning.” KDAs provide starting points from which an organization can make and measure progress in innovation management competency. KDAs facilitate holistic transformation planning by pinpointing the critical competency “linchpins” and their required level of institutionalization and specialization that will increase the organization's innovation capacity.

IMBCM Key Disciplines

Each key discipline area is described in terms of key disciplines. The key disciplines describe the practices and behaviors that contribute most to operationalizing the key discipline area. The specific disciplines to be executed in each key discipline area evolve as the organization progresses up the levels of proficiency.

IMBCM Proficiency Levels

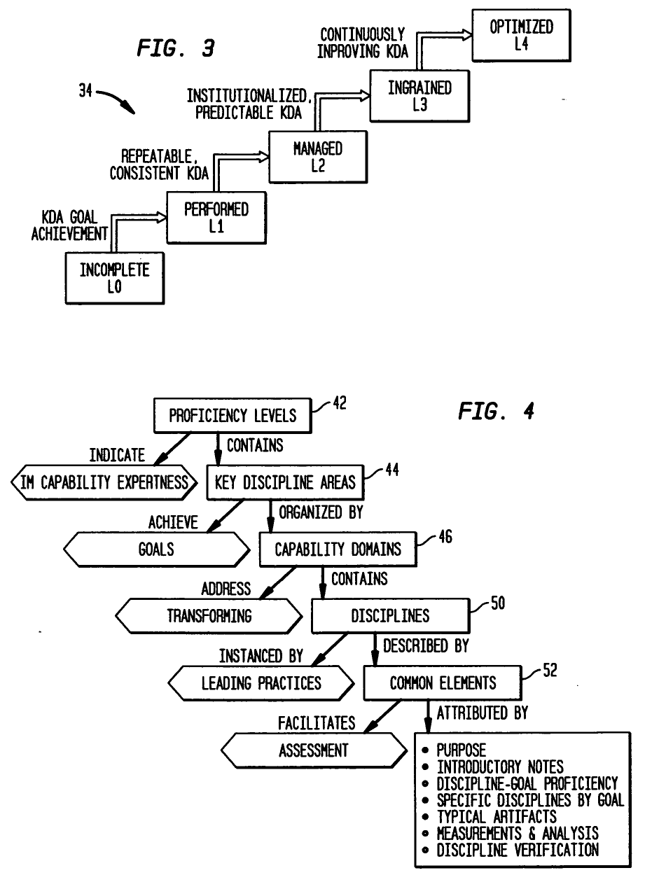

The proficiency levels and generic model components focus on building the organization's ability to pursue improvement within an individual capability or within multiple KDAs. As illustrated in FIG. 3, proficiency levels L0-L4 provide a recommended order 34 for how to tackle such improvement initiatives. For each KDA, a proficiency level is comprised of related specific and generic disciplines that, when performed, achieve a set of goals that lead to improved KDA performance.

FIG. 4 illustrates the relationship of the constituent parts of an innovation management (IM) capability. Proficiency levels 42 focus on growing the organization's ability to perform, control, and improve its expertise in a KDA 44. The levels reflect a discrete, incremental implementation of a particular KDA and gauge the corresponding improvement. KDAs establish a set of disciplines that, when performed collectively, achieve a set of goals considered critical for improving capability proficiency. The KDAs are organized by capability domain 46 that facilitates holistic transformation planning. A KDA's set of disciplines 50 is described using a standardized format, call common elements 52. KDAs are instanced by leading practices that provide a recommended solution for addressing KDA performance gaps.

The IMBCM can be considered or represented as a multi-dimensional grid structure. The “Y” dimension represents the hierarchical organizing design of a capability, whereby the first-order decomposition is the domain, the second order is the KDA, the third-order is foundational/specific, the fourth-order is the key discipline, the fifth-level is generic/specific, and the sixth-level is goal/discipline. The “X” dimension represent the dual nature of a proficiency level, whereby both degree of institutionalization and degree of specialization are examined for the level of investigation being performed (i.e., capability-level, domain-level, KDA level, etc.). The “Z” dimension represents the collaborative interface design of a capability, KDA, key discipline, and of the proficiency level.

This grid-like structural feature is the basis for assessing an organization's current position, positioning its desired/optimal state, and calculating the detailed, discipline-level path for improvement.

For example, the IMBCM may use the following data types in the assessment calculus for proficiency at the KDA, domain, and capability levels:
quantitative business performance metrics,
tangible evidence of instances of discipline practice,
tangible evidence of instances of discipline technique maturity,
intangible evidence of instance of discipline practice, and
intangible evidence of discipline technique maturity.

The assessment procedure preferably ensures that the data collected for a discipline includes multiple source types and multiple data types.

As indicated hereinabove, it should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of assessing a client capability, comprising the steps of:
providing a business model for a company, said model having defined capabilities, capability domains, key discipline areas having metrics, and specified proficiency levels including best practices proficiency levels;
determining for each of said metrics a proficiency level for said client for each of said key discipline areas;
rolling up said proficiency levels for said client by said capability; and
communicating to said client, said proficiency levels for said client and said best practices proficiency levels.

2. A method according to claim 1, wherein the defined capabilities include: Market Planning, Portfolio Management, Platform Management; and Pipeline Management.

3. A method according to claim 1, wherein the key discipline areas identify issues that need to be addressed in order to achieve said proficiency level.

4. A method according to claim 1, wherein each key discipline area includes a set of specific and generic goals.

5. A method according to claim 1, wherein each of said key discipline areas is described by a set of key disciplines, said key disciplines describing practices and behaviors that contribute to operationalizing said key discipline area.

6. A method according to claim 1, wherein:
a set of proficiency levels is provided for each of said defined capabilities; and
said set of proficiency levels provided for each of said defined capabilities provides a recommended order for how to improve said capability.

7. A method according to claim 1, wherein:
a set of key discipline areas is associated with each of said defined capabilities; and
said set of key discipline areas associated with said each of said defined capabilities establishes a set of disciplines that, when performed collectively, achieve a set of goals needed to improve the proficiency of said each of said defined capabilities.

8. A system for assessing a client capability, comprising:
means providing a business model for a company, said model having defined capabilities, capability domains, key discipline areas having metrics, and specified proficiency levels including best practices proficiency levels;
means for determining for each of said metrics a proficiency level for said client for each of said key discipline areas;
means for rolling up said proficiency levels for said client by said capability; and
means for communicating to said client, said proficiency levels for said client and said best practices proficiency levels.

9. A system according to claim 8, wherein the defined capabilities include: Market Planning, Portfolio Management, Platform Management; and Pipeline Management.

10. A system according to claim 8, wherein:
said key discipline areas identify issues that need to be addressed in order to achieve said proficiency level;
each key discipline area includes a set of specific and generic goals; and
each of said key discipline areas is described by a set of key disciplines, said key disciplines describing practices and behaviors that contribute to operationalizing said key discipline area.

11. A system according to claim 8, wherein:
a set of proficiency levels is provided for each of said defined capabilities; and
said set of proficiency levels provided for each of said defined capabilities provides a recommended order for how to improve said capability.

12. A system according to claim 8, wherein:
a set of key discipline areas is associated with each of said defined capabilities; and
said set of key discipline areas associated with said each of said defined capabilities establishes a set of disciplines that, when performed collectively, achieve a set of goals needed to improve the proficiency of said each of said defined capabilities.

13. A program storage device readable by machine, tangibly embodying a program of instructions executable by the machine to perform method steps for assessing a client capability, said method steps comprising:
providing a business model for a company, said model having defined capabilities, capability domains, key discipline areas having metrics, and specified proficiency levels including best practices proficiency levels;
determining for each of said metrics a proficiency level for said client for each of said key discipline areas;
rolling up said proficiency levels for said client by said capability; and
communicating to said client, said proficiency levels for said client and said best practices proficiency levels.

14. A program storage device according to claim 13, wherein the defined capabilities include: Market Planning, Portfolio Management, Platform Management; and Pipeline Management.

15. A program storage device according to claim 13, wherein:
said key discipline areas identify issues that need to be addressed in order to achieve said proficiency level; and
each key discipline area includes a set of specific and generic goals.

16. A program storage device according to claim 13, wherein each of said key discipline areas is described by a set of key disciplines, said key disciplines describing practices and behaviors that contribute to operationalizing said key discipline area.

17. A program storage device according to claim 13, wherein:
a set of proficiency levels is provided for each of said defined capabilities;
said set of proficiency levels provided for each of said defined capabilities provides a recommended order for how to improve said capability;
a set of key discipline areas is associated with each of said defined capabilities; and
said set of key discipline areas associated with said each of said defined capabilities establishes a set of disciplines that, when performed collectively, achieve a set of goals needed to improve the proficiency of said each of said defined capabilities.

18. A method of deploying a computer program product for assessing a client capability, wherein, when executed, the computer program performs the steps of:
providing a business model for a company, said model having defined capabilities, capability domains, key discipline areas having metrics, and specified proficiency levels including best practices proficiency levels;
determining for each of said metrics a proficiency level for said client for each of said key discipline areas;
rolling up said proficiency levels for said client by said capability; and
communicating to said client, said proficiency levels for said client and said best practices proficiency levels.

19. A method according to claim 18, wherein the defined capabilities include: Market Planning, Portfolio Management, Platform Management; and Pipeline Management.

20. A method according to claim 18, wherein:
said key discipline areas identify issues that need to be addressed in order to achieve said proficiency level; and
each key discipline area includes a set of specific and generic goals.

21. A method according to claim 18, wherein each of said key discipline areas is described by a set of key disciplines, said key disciplines describing practices and behaviors that contribute to operationalizing said key discipline area.

22. A method according to claim 18, wherein:
a set of proficiency levels is provided for each of said defined capabilities;
said set of proficiency levels provided for each of said defined capabilities provides a recommended order for how to improve said capability;
a set of key discipline areas is associated with each of said defined capabilities; and
said set of key discipline areas associated with said each of said defined capabilities establishes a set of disciplines that, when performed collectively, achieve a set of goals needed to improve the proficiency of said each of said defined capabilities.
